(19) United States
(12) Patent Application Publication
(10) Pub. No.: US 2009/0182718 A1
(43) Pub. Date: Jul. 16, 2009

(54) Remote Segmentation System and Method Applied To A Segmentation Data Mart

(75) Inventors: Matthew Waclawik, San Diego, CA (US); Sonya Rikhtverchik, Mountain View, CA (US); Daniel Krans, Poway, CA (US); Daniel Thomas Smith, San Diego, CA (US); Timothy C. Lograsso, Sunland, CA (US); Adam Thomas Gillespie, San Diego, CA (US); Robert N. Groth, Folsom, CA (US); Walter Rezin Mann, San Francisco, CA (US); Christopher John McGreal, San Diego, CA (US)

Correspondence Address: NORTH OAKS PATENT AGENCY, 45 ISLAND ROAD, NORTH OAKS, MN, 55127, US

(73) Assignee: Digital River, Inc., Eden Prairie, MN (US)

(21) Appl. No.: 12/394,858

(22) Filed: Feb. 27, 2009

Related U.S. Application Data
(63) Continuation-in-part of application No. 12/116,125, filed on May 6, 2008.
(60) Provisional application No. 60/916,685, filed on May 8, 2007.

(51) Int. Cl. G06F 17/30; G06Q 30/00

(52) U.S. Cl. 707/3; 707/10; 705/7; 707/E17.046; 707/E17.014; 707/100

(57) ABSTRACT

Remote segmentation applied to a segmentation data mart allows a marketer to create a personalized email campaign for a selected segment of customers. Segmentation data is collected from a plurality of third party sources, imported and cleansed. The marketer may query a data mart with a user-defined rule created with parameters selected from fields available in the data mart. The marketer submits the query and is presented with a count with which the marketer may determine if the segment will be cost effective for the marketing campaign. If the count is acceptable, the query is saved. Later, when the marketer creates the email message for a particular campaign, s/he assigns the segment to the campaign. When the campaign is released, the query extracts email addresses currently meeting the criteria of the query and uses the addresses for distributing the email.

### RELATED APPLICATIONS

This application is a continuation-in-part of U.S. application Ser. No. 12/116,125 filed on May 6, 2008, entitled “Remote Segmentation System and Method”, which claimed the benefit of U.S. Provisional Application No. 60/916,685 filed 8 May 2007, entitled “Remote Segmentation,” both of which are incorporated herein by reference.

### FIELD OF THE INVENTION

The present invention relates generally to relational database management systems and applications using such systems. In particular, it relates to a software system that collects segmentation data.

### BACKGROUND OF THE INVENTION

Targeting customers with email marketing is like going on a date. The electronic commerce (e-commerce) company makes the customer comfortable by providing relevant information in a personal message, and the customer tries to understand what the e-commerce company is all about. If the customer likes the e-commerce company there is a second date, and then eventually marriage.

Accordingly, the ability to market a product or service to individuals who are accessible on the Internet is becoming increasingly important. Email systems exist today for sending email to a target set of email addresses for purposes such as marketing, information acquisition, and otherwise. A system for sending email to a number of email targets for such purposes is called an email campaign or email marketing system. Together, an internet-based email marketing system provides marketers with a fast and inexpensive way to send a personal message to potential customers.

The key to a successful email campaign is relevance—personalizing the message. It's finding the people (“targets”) who have shown interest in the product offering or who may be most likely to be interested. To facilitate relevance, marketers assemble a list of subscribers; people who have “opted in” (signed up or registered) to receive email from the marketer. The marketer gathers as much data on the subscribers as it possibly can in order to understand them better and to divide them into groups or segments, according to defining characteristics, like interests or behaviors. The marketer may then direct a personal marketing message to only those target subscribers who will be most interested. Relevance increases the effectiveness of the campaign and provides the highest rate of return on the marketing investment.

In addition, the Internet provides the capability to provide services to customers without requiring them to install additional software on their local computers. Specifically, by exploiting the customer's web browser, all functional logic and all data can reside at a remote server rather than at the customer's local computer (i.e., the client). As such, the customer, via instructions submitted through web pages that are displayed in the web browser, can remotely invoke the functional logic to view, create, update, delete, utilize or otherwise modify the data residing on the remote server.

Furthermore, computer databases or similar constructions are powerful tools for storage, organization, retrieval and other handling of various types of information. However, there are different database models, or formats, for data access that are incompatible with each other, and may also be incompatible with, or remarkably different from, an object programming application. In this respect, complex relationships between objects present in the object programming application may be entirely absent in a relational or object database being accessed or updated. Nonetheless, many of these database types have achieved a high level of popularity and proliferation.

A distributed database is a database in which portions of the database are stored on multiple computers within a network. Users have access to the portion of the database at their location so that they can access the data relevant to their tasks without interfering with the work of others. A centralized distributed database management system (DDBMS) manages the database as if it were all stored on the same computer. The DDBMS synchronizes all the data periodically and, in cases where multiple users must access the same data, ensures that updates and deletes performed on the data at one location will be automatically reflected in the data stored elsewhere.

Collections of data such as in a database can be distributed across multiple physical locations. A distributed database is distributed into separate partitions and fragments. Each partition and fragment of a distributed database may be replicated. Besides distributed database replication and fragmentation, there are many other distributed database design technologies. For example, there are local autonomy, synchronous and asynchronous distributed database technologies. These technologies' implementation depends on the needs of the business and the sensitivity and confidentiality of the data to be stored in the database, and hence the price the business is willing to spend on ensuring data security, consistency and integrity. Also, a database server is the software managing a database, and a client is an application that requests information from a server. Each computer in a system is a node. A node in a distributed database system acts as a client, a server, or both, depending on the situation.

Furthermore, there are advantages of distributed databases. This is reflected in organizational structure. Database fragments are located in the departments they relate to. A department can control the data about them, giving them local autonomy. There is improved availability; a fault in one database system will only affect one fragment, instead of the entire database. Additionally, there is improved performance because data is located near the site of greatest demand and the database systems themselves are parallelized, allowing load on the databases to be balanced among servers. A high load on one module of the database will not affect other modules of the database in a distributed database.

From an economic standpoint, it costs less to create a network of smaller computers with the power of a single large computer. Also, systems can be modified, added and removed from the distributed database without affecting other modules (systems). However, increased complexity and a more extensive infrastructure means extra labor costs. Furthermore, remote database fragments must be secured, and they are not centralized so the remote sites must be secured as well. The infrastructure must also be secured (e.g., by encrypting the network links between remote sites).

Email service providers often face problems accessing and analyzing customer data. A marketer may employ a number of sales channels—for example, retail store, e-commerce sales, catalog sales—and the transaction data may be spread among several databases. In addition, the marketer may have access to customer surveys or online behaviors tracked by web analytics and email marketing systems. The problem is how to access and analyze this information in order to develop the most complete picture of the preferences, behaviors and demographics of the customer. The solution is to have database administrators and application developers retain control over their data warehouse and allow marketers to have the flexibility to change variables in their segmentation without making an additional request to the information technology (IT) staff.

Businesses often struggle to maintain a working relationship between transactional and marketing data. Often, the data required to make decisions lives in a custom data warehouse which can only be queried via custom requirements in an on-demand fashion. Making transaction level data available directly to a marketer can be cause for concern for IT staff and often requires some knowledge about relational databases and how to interact with them.

Accordingly, there is a strong need for more efficient and flexible data collection from a third party to be applied to an existing database. There is a need for an internal system to make segmentation calls to other non-email service provider data sources and those sources, combined with client requirements. The present invention provides a solution to these needs and other problems, and offers other advantages over the prior art.

### BRIEF SUMMARY OF THE INVENTION

The present invention is related to a software system that solves the above-mentioned problems. Some sort of behavior or transaction information about an individual may be located in a database in various areas. It will be understood by one of ordinary skill in the art that these areas may be disjointed or separated. The behavior information can include profiles of subscribers. The customer profiles have data such as demographics, preferences, and behaviors, but are not limited to this list. Customers can also subscribe to an email list. Subscriber list profiles can be located in various e-commerce platforms. Furthermore, the database may be owned by a third party, including clients and vendors. In one embodiment of remote segmentation system and method, a request is sent to an owner of a database for a subset of information. The response includes a list of people that match the request.

In a very simple example, the request asks for all people who did not purchase a Movado 24-carat gold plated watch. The response will then segment the database to contain all customers who purchased items excluding the specified watch, without saving the segment and overloading the current system. A user, marketer, or client can then send a message to the customers in the segment.

Also, in a preferred embodiment, remote segmentation provides the ability for a cast or bid party to define a user interface in an application that exposes or limits parameters to access the data (such as customer behavior). This allows a user to make categories, items, parameters, etc. available in the flexible user interface based on definitions entered by the third party customer.

In another embodiment, a user may receive fresh or updated data requests through the user interface for data segments. For example, the user may request “freshness” values for a data expiration window without making multiple requests for the entire data stores, thereby reducing strain on the third party. Also, in a further functional embodiment the format of the response and requests may be in extensible markup language (XML) or text format. Additionally, while utilizing remote segmentation as a whole, a user has the ability to approve peripheral actions such as email campaign functionality. Finally, in another preferred embodiment, the user has the ability to request a count or number of the specified data instead of the actual data itself.

An alternative embodiment uses a remote segmentation system to extract data from a segmentation data mart which has been populated by data from a number of sources. This embodiment allows users to combine data from, for example, multiple commerce system(s), web analytics system(s) and email marketing system(s) in order to obtain the most relevant list of subscribers for any marketing offer.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 shows a flow diagram for an e-commerce system working with a remote segmentation system.

FIG. 2 describes a sample remote segmentation system user interface.

FIG. 3 illustrates an overview flow diagram of the remote segmentation system in more detail.

FIG. 4 illustrates a screen shot of setting a rule for filtering by time frame.

FIG. 5 illustrates a screen shot from FIG. 4 further including filtering by locale and currency.

FIG. 6 illustrates a screen shot of setting a rule for customer purchases.

FIG. 7 illustrates a screen shot of adding user identification codes.

FIG. 8 shows a screen shot for selecting a box for time frame.

FIG. 9 shows a screen shot for adding a username.

FIG. 10 illustrates a screen shot for adding a password.

FIG. 11 illustrates a screen shot for changing a date.

FIG. 12 illustrates a screen shot for changing a locale.

FIG. 13 shows a screen shot for changing currency.

FIG. 14 shows a screen shot combining FIGS. 6-13.

FIG. 15 illustrates a screen shot for username, password, and Uniform Resource Locator file name.

FIG. 16 illustrates a screen shot for choosing search criteria.

FIG. 17 is a high level view of the data flow for a remote segmentation system accessing a segmentation data mart.

FIG. 18 is an overview of the inputs and outputs of a remote segmentation system accessing a segmentation data mart.

FIG. 19 is an exemplary screen for configuring a stored segment.

FIG. 20 further displays the configuration of a stored segment.

FIG. 21 shows the results page with count display which also allows the user to modify or update a segment.

### DETAILED DESCRIPTION

Remote segmentation is a process by which segmentation data is collected from a third party and applied to an existing database. In a preferred embodiment of remote segmentation, a definition is added that makes the local system aware of all the possible segmentation dimensions in a way that is presentable to the user as well as transmittable to a third party (in house or other company) which processes the segment and returns the result.

Some e-commerce companies offer the ability to send a request for a segment and get a result, but it is up to the user to wrap a user interface around that. In a preferred embodiment, remote segmentation is a system that can consume the types of data a segmentation engine can crunch and giving the user an interface that changes based on the different types of data the third party holds.

For example, a user wishes to create an email campaign for an airline company that has a promotion for discounted tickets to Greece. Database A, located in a remote location from the company, contains a list of one hundred email addresses. The user logs into a system that has a user interface and specifies a list of parameters. The parameters create a query for people who speak the Greek language. A remote segmentation engine sends the query to database A with a request for how many people speak Greek. The database A sends back a reply with Bob Smith's name and email (or any other requested information) as a person who speaks Greek. The remote segmentation engine then utilizes Bob Smith in a segment. The user then can send a message to the segmented population with details about discounted tickets. Thus, the remote segmentation system does not store the segment or any information about the segment. Instead, the system sends requests to remote databases and matches the request to create an intersection of information. It will be understood by one of ordinary skill in the art that the remote database could be any external source of information. It will also be understood that a segment can also be an external group.

The customer profiles have data such as demographics, preferences, and behaviors, but are not limited to this list. Customers can also subscribe to an email list. Subscriber list profiles can be located in various e-commerce platforms.

Furthermore, the database may be owned by a third party, including clients and vendors.

Definitions in Table 1 are intended to clarify terms and concepts used within this document.

TABLE 1
Commonly Used Terms

| Term | Definition |
|---|---|
| ISP | Internet Service Provider at which a subscriber's email |
| | address resides. |
| Subscriber | A contact within an e-commerce system which has an email address. |
| Deliverability | A word used to describe the success of an email message's |
| | effectiveness. This is measured with the fields in the e- |
| | commerce system that indicate how many messages |
| | reached recipients and how many messages were bounced, |
| | received, etc. |
| Smart List | The name for a feature in an e-commerce system that is a |
| | saved query. These saved queries can be used to generate |
| | a list of subscriber email addresses located in the e- |
| | commerce database. |
| Segment | A specific example of a Smart List; a saved query generated |
| | using remote segmentation accessing a particular |
| | segmentation database (Segmentation Data Mart). |
| Segmentation | A segmentation database containing data extracted and |
| Data Mart | imported from a plurality of sources, that may have been |
| | further enhanced by data appending, updating and cleansing |
| | services. |
| Exclusion | The ability to choose a list of email addresses in a system |
| | which does not include any of the email addresses on |
| | another list. |
| Marketer | A marketer is someone whose job it is to present a good or |
| | service to the market place in an attractive way so that |
| | others will be tempted to buy it. For purposes of this |
| | document, it may be interchanged with a user, staff, |
| | customer or administrator. |
| DTD File | A Document Type Definition (DTD) defines the legal building |
| | blocks of an XML document. It defines the document |
| | structure with a list of legal elements and attributes. A DTD |
| | can be declared inline inside an XML document, or as an |
| | external reference. It may be used to describe an import API |
| | used to populate a data mart. |
| LifeTime Value | LTV is an example of a segment useful to marketers. This |
| (LTV) | segment identifies subscribers whose past and future |
| | purchases will contribute a certain value to the marketer. |
| Email Message | An email message is a communication to a marketer's |
| | prospective customer (a subscriber) in an email marketing |
| | campaign. Messages utilizing remote segmentation may be |
| | of any type, including one-time, recurring, timed-release, etc. |
| Results | Results returned from the segmentation data mart refer to |
| | reports, counts and data feeds provided to an email |
| | marketing system for use as a distribution list in a marketing |
| | campaign. |
| #PCDATA | Parsed character data. This term is used to represent data |
| | submitted between XML tags in a DTD file. |

Remote segmentation system and method provides a method for customers to populate groups in the system without having to make application programming interface (API) calls to the email service provider system. Remote segmentation has a remote control functionality that allows users to populate groups in the system from an external data source without logging into the system. A data source can be any file transfer protocol (FTP) site where customers post files of email addresses. The system has a checking mechanism in a message sending process that identifies when a message contains an external group and when it does not contain an external group. Furthermore, the system includes an end tag convention that customers use with external group files to ensure file retrieval.

In a preferred embodiment of remote segmentation system and method, the user interface allows the creation of external groups. Furthermore, it allows the user to define an external data source for the group and to include the definition of the path to the external group FTP location. The user can change the number of fields in the external group file in the remote location. Remote segmentation system also has approval process screens that include an approval process for the first few times the external group is utilized. The screen allows the user to view the message and have buttons that allow the user to approve the message for sending or send it back to drafts database. Failure state screens in the user interface identify failure messages when a file does not exist at the location specified for the external group. Additionally, in client accounts and subaccounts the remote segmentation feature may be activated or deactivated.

In another embodiment, a user may receive fresh or updated data requests through the user interface for data segments. For example, the user may request “freshness” values for a data expiration window without making multiple requests for the entire data stores, thereby reducing strain on the third party. The user can define the following properties for an external group: type of file, number of fields, define field names, order of fields, and minimum refresh time. Minimum refresh time defines whether the contents of the external group are to be updated each time a message is sent using the external group. This would be defined by a time parameter. For example: if update time=now (0) then the external group would be populated with data from the external source each time the group is used in a message send. If the update time=once per week (7) then the external group would update the contents of the group from the external source once per week. Also, the user has the ability to request a count or number of the specified data instead of the actual data itself.

It will be understood by one of ordinary skill in the art that the user interface is variable and defined as a part of remote segmentation. The resulting user interface changes based on what is required of the remote segmentation engine. Remote segmentation is a system that can consume the types of data a segmentation engine can crunch and giving the user an interface that changes based on the different types of data the third party holds.

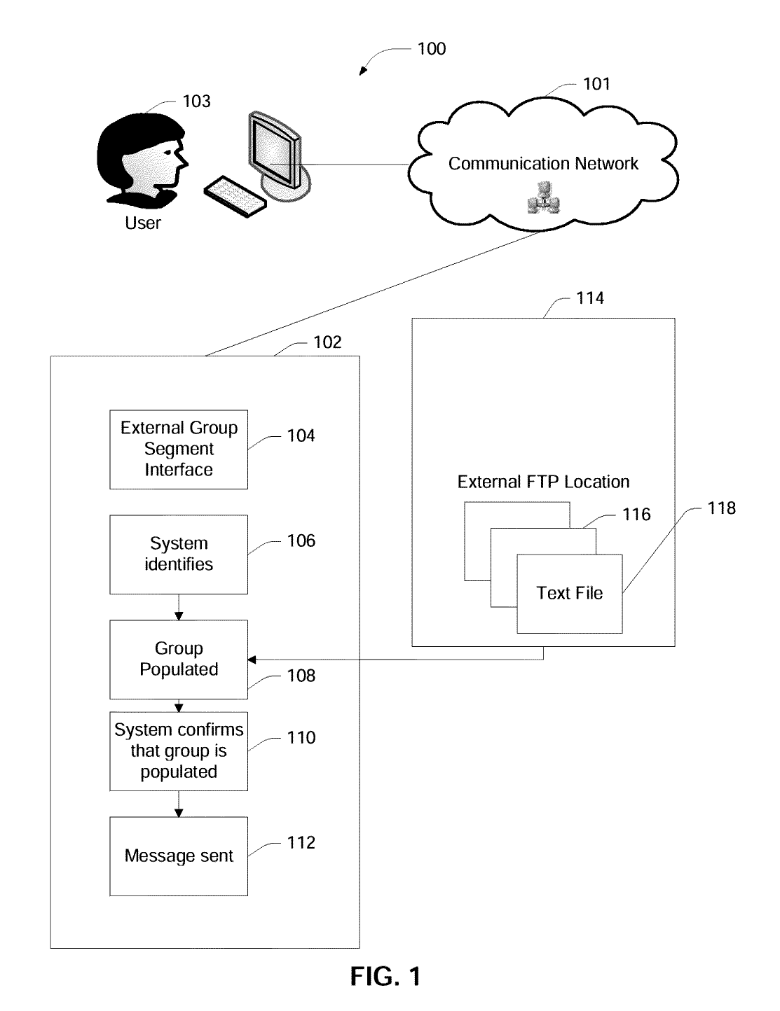

FIG. 1 shows a flow diagram 100 for an e-commerce system working with the remote segmentation system. It will be understood that a user 103 accesses a communication network 101 to work with remote segmentation system and method. Box 102 illustrates an e-commerce system. External group interface 104 is the information needed to access remote segments. It will be understood that external group is another name for a remote segment. External group interface 104 contains information such as names of files, definitions for remote segments, types of actions needed to be performed, and protocols such as File Transfer Protocol (FTP), Hypertext transfer protocol (HTTP), and Gopher. It will be understood by one of ordinary skill in the art that the information in External group interface 104 is not limited to those listed.

Referring again to FIG. 1, remote segmentation system and method identifies 106 whether or not a message is utilizing an external group. Then, a group is populated 108 by getting a reply back for a list of names to send to a segmented population. This reply is taken from an external FTP location (for example) and contains a text file 118 and other external group files 116 that have a list of email addresses. The system confirms that the group is populated 110 and the message is sent 112. Table 2 outlines an example use case of remote segmentation.

TABLE 2
Use Case 1
Use Case 1

A system user creates a FTP location where they can post files
containing email addresses, first name, last name, and custom fields.
The user then creates external groups in the system on a new
external groups page. This page allows them to create groups and to
identify the path and login information for the location of the data for
the external group. Custom fields can be mapped in this step. The
user also configures minimum refresh time in days and data base
action (clear and replace, merge, etc.).
The user then creates messages that will use the external groups and
schedules them for sending.
At the time of message send, the system detects that the message to
be sent contains an external group. The system uses the FTP
information that was entered into the system on the external groups
page. The system retrieves the email addresses and fields that were
located in the specified external groups file and places them in the
system using the import process. The message is then sent using
that data.

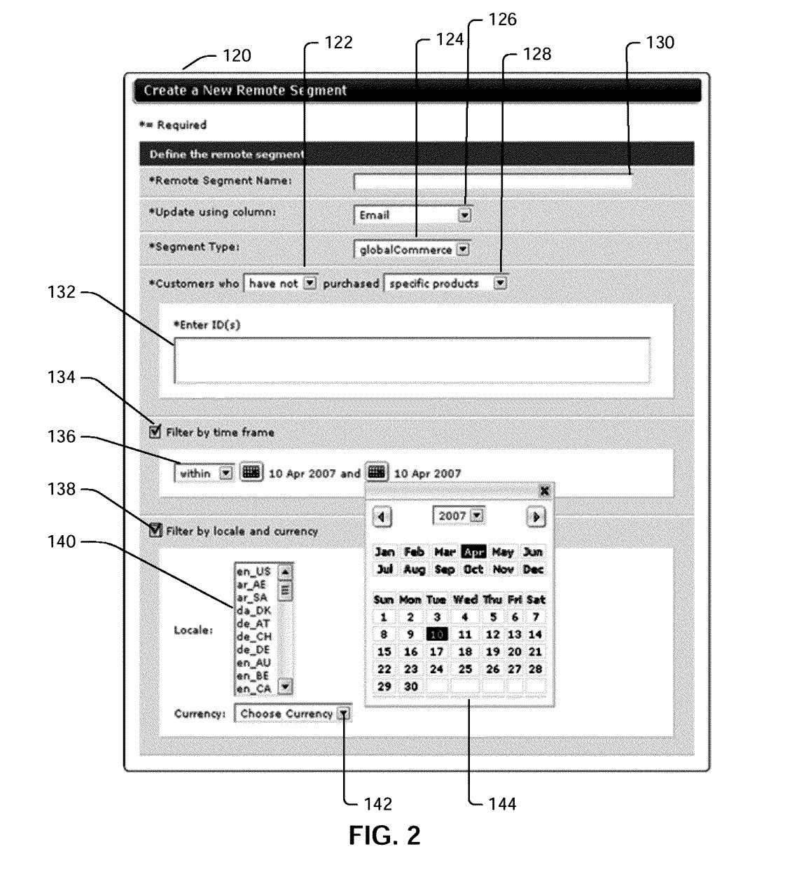

Referring now to FIG. 2, a sample remote segmentation user interface 120 is shown. In this interface, the user can define attributes for filtering an offset database into segments. For example, the user can choose a remote segment name 130 to classify the group they are about to filter. Furthermore, the user can choose to update a column type 126 and a segment type 124. In this particular interface 120, the filters are being set for a commercial system such as shopping online in a catalog. Accordingly, the user can choose to specify in box 122 and box 128 customers who have or have not purchased a product. The boxes 122 and 128 are drop down lists containing various options. Enter Identifications (IDs) 132 allows the user to add IDs to define the remote segment. The user can check filter by time frame box 134 to choose from drop down menu 136 the range of dates the remote segment should appear from (also in monthly format 144). Also, the user can check a filter by locale and currency box 138. This box 138, once checked, reveals locale options 140 and currency options 142.

FIG. 3 illustrates an overview flow diagram of the remote segmentation system in more detail. Segment definition 148 shows how the user interacts with the interface from FIG. 2. First, extensible markup language (XML) is processed to present the user interface (shown in box 150). Then, the defined interface is presented. Next, the user can select dimensions 146 and their required values. The user can save selected dimensions 152 as a segment for future use. This information (selected dimensions) is saved in a database. Box 158 shows a user flow for messaging from the remote segments. The user selects a saved segment 154 from a mailing list (such as an email campaign). This sends a request 166 to a remote segmentation engine. The user then waits for request 168 to return and update the interface with total number in segment. Thus, information is sent to a remote system which then matches the information to a list. The resulting segment is applied 170 to the database. In other words, a query is sent to an offset database. The query has parameters, or filters, that list particular attributes. The offset database matches to the filters and then sends back a list for messaging purposes. Then, the segment is applied from the database to the message being composed 172. The message is created 160 and sent 162 to the mailing list. It will be understood that step 172 is a standard mail merge process. Steps 166, 168, 170 and 172 are the backend processing portion 164 of remote segmentation system.

In a preferred embodiment of remote segments, for successful implementation W3C Extensible Markup Language (XML) 1.0 standard (http://www.w3.org/XML/Core/) as well as the XML Schema 1.1 standard (http://www.w3.org/XML/Schema) can be utilized. Furthermore, remote segment system makes use of some industry standard encryption, authentication and filtering methods to maintain a high level of security when transmitting and receiving customer data. Using a combination of these technologies, customer data is secure and cannot be stolen while in transit between the client and email service provider. Some of the technologies employed by remote segments are Secure Sockets Layer (SSL), Secure FTP (FTP over SSL), HTTP Authentication and IP Filtering.

Moreover, an email service provider's remote segment functionality is comprised of three components which, when used together, create the usable remote segment. The first component is a remote segment type. The remote segment type template provides a set of parameters for the remote segment and at the very basic level gives the remote segment type a name and set of configuration options that can be manipulated by the user. The second component is the saved remote segment. The saved remote segment marries the defined remote segment type with the user defined parameters to create a logical request to the third component, a remote system. The remote system is a client implemented and maintained interface used by email service provider's remote segment functionality to request segment data from the client. The interface returns any modifications to the remote segment definition so the email service provider system knows where to locate the segment data.

Understanding an email service provider's interpretation of each user interaction with the XML configuration and how it affects the outcome of each remote segment is critical to successful implementation because it allows staff to define a flexible set of parameters a marketer can use to retrieve segmentation information, yet defines a box that allows the staff to protect its internal infrastructure from impossible queries.

The XML configuration cascades across the three different components of a remote segment and allows modification of previous definitions at each stage. The staff's role is to create an XML configuration for the remote segment type that defines a set of parameters the marketer can use to segment, (e.g., birth date, last purchase date, purchase categories). The request is made to the client's remote segment interface which responds with any changes to the original configuration.

### Component 1: Remote Segment Type

In a preferred embodiment of remote segmentation system and method, the remote segment type defines a set of configuration options used by an email service provider to access the remote segmentation information as well as the options available to the marketer when defining which segment they want to mail. A basic remote segment type starts with the following XML document:

<?xml version=”1.0” ?>
<remote_segment_type>
<name>Name</name>
</remote_segment_type>

Furthermore, the XML document is expanded to define parameters surrounding the request communication protocol, request method, username and password. Note that if the request transport is defined as “none,” the request is skipped and the remote segment data file is requested immediately.

```
<?xml version=”1.0” ?>
<remote_segment_type>
  <name>Name</name>
  <request_transport>http</request_transport>
  <request_method>get</request_method>
  <request_url>http://www.clientsite.com/segments/</request_url>
  <request_username>test</request_username>
  <request_password>test</request_password>
</remote_segment_type>
```

Next, data transport, location and access information is added to reflect a data location. The resulting XML configuration contains “name” plus ten core XML tags needed by the remote segments functionality to retrieve and process data from the client's system.

```
<?xml version=”1.0” ?>
<remote_segment_type>
  <name>Name</name>
  <request_transport>http</request_transport>
  <request_method>get</request_method>
  <request_url>http://www.clientsite.com/segments/</request_url>
  <request_username>test</request_username>
  <request_password>test</request_password>
  <data_transport>ftp</data_transport>
  <data_host>ftp.bluehornet.com</data_host>
  <data_username>test</data_username>
  <data_password>test</data_password>
  <data_file>test_file.txt</data_file>
</remote_segment_type>
```

Because data files are expected to be generated dynamically by a marketer's segmentation request, the request response can be a subset of the configuration XML defining the data access parameters. It will be understood by one of ordinary skill in the art that the following example XML could be in response to a request made to the client's interface.

```
<?xml version=”1.0” ?>
<remote_segment_type>
  <data_transport>ftp</data_transport>
  <data_host>ftp.bluehornet.com</data_host>
  <data_username>test</data_username>
  <data_password>test</data_password>
  <data_file>test_file.txt</data_file>
</remote_segment_type>
```

Furthermore, the ability to override previously specified parameters gives the client flexibility to manipulate data storage locations, usernames, passwords and file names without having to make the email service provider remote segment functionality aware of the changes ahead of time.

### Forms: Overview

The XML configuration allows the client's staff to create a marketer friendly interface to interact with available segmentation parameters. The available user interface elements are:
Text box—equivalent to an HTML <input type=“text”>
Password box—equivalent to an HTML <input type=“password”>
Checkbox—equivalent to an HTML <input type=“checkbox”>
Text area—equivalent to an HTML <textarea>
Dropdown—equivalent to an HTML <select>
Multibox—equivalent to an HTML <select multiple>
Decision—a logical sentence that answers a variable question
Date frame—a calendar that can select “before,” “after,” “on,” and “within”

The best way to determine what XML tags and attributes are supported is via the available XSD. There is also a tag reference in Table 4.

Additionally, the XML configuration supports a set of attributes on each form object. Two attributes are required for each form object: “container” and “name” (“d1_name” for a Decision). If any “name” or “d_name” attribute is named the same as one of the ten core xml tags covered in the previous section, the value of that form object will override the originally defined XML value. This functionality is designed to let staff to build in overrides to their own configuration when exposed to the marketer.

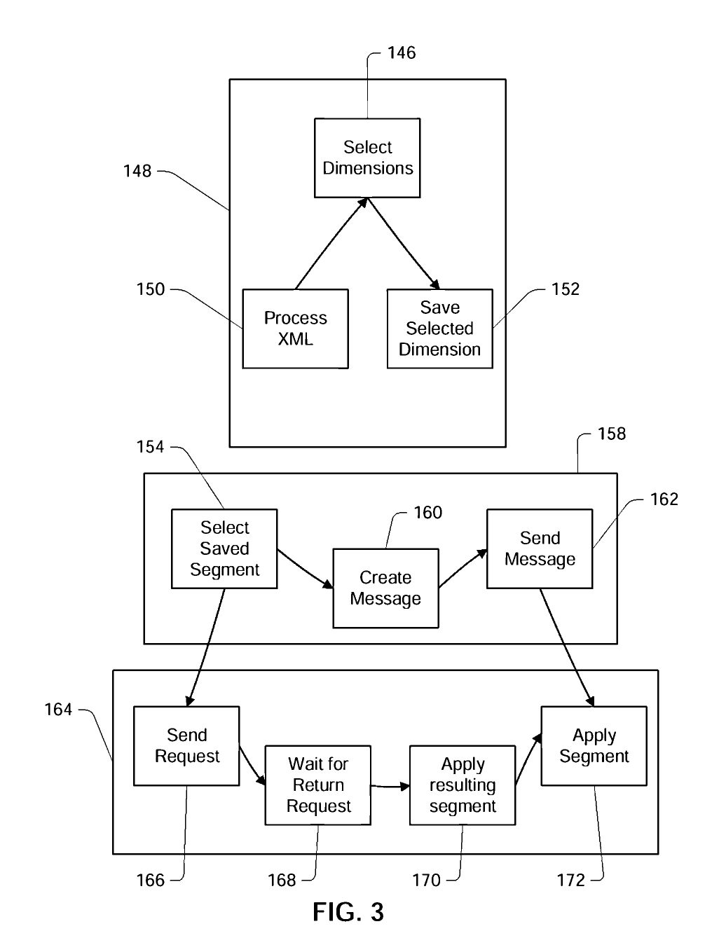

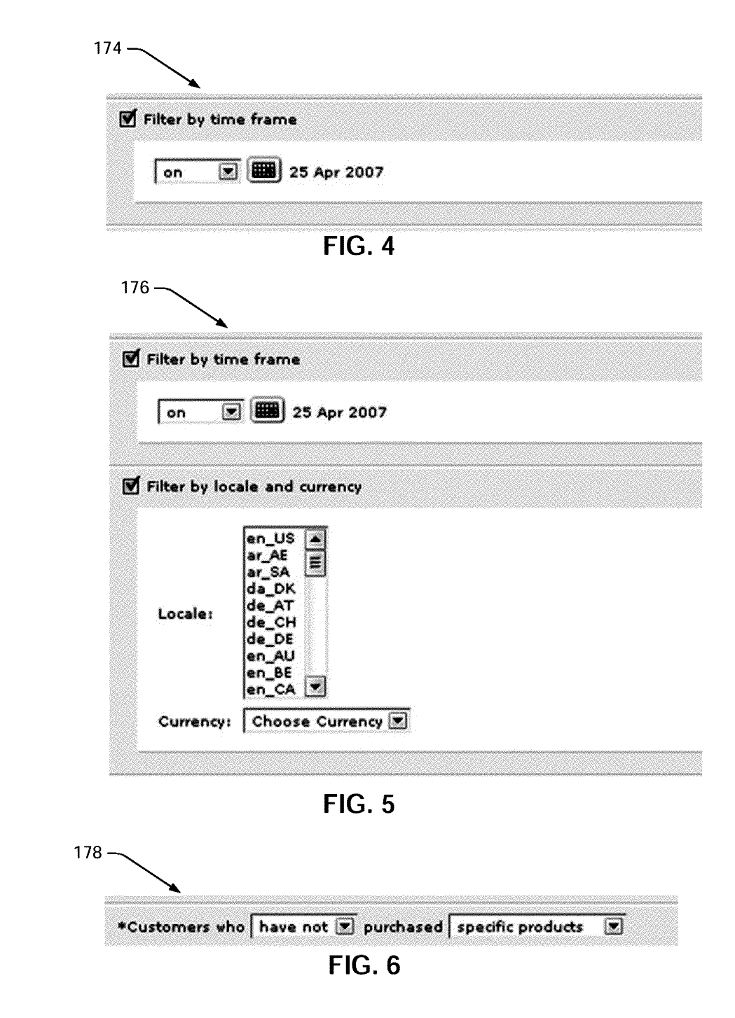

Expanding upon the previously defined XML, the following example offers the marketer the ability to enter a date range which will be transmitted to the client's interface as “date.” FIG. 4 is the resulting user interface 174 from the following XML configuration example.

```
<?xml version=“1.0” ?>
<remote_segment_type>
  <name>Name</name>
  <request_transport>http</request_transport>
  <request_method>get</request_method>
  <request_url>http://www.clientsite.com/segments/</request_url>
  <request_username>test</request_username>
  <request_password>test</request_password>
  <data_transport>ftp</data_transport>
  <data_host>ftp.bluehornet.com</data_host>
  <data_username>test</data_username>
  <data_password>test</data_password>
  <data_file>test_file.txt</data_file>
  <form>
    <checkbox name=“t1” toggle=“date” container=“field”>
      Filter by time frame
    </checkbox>
    <dateframe container=“display” name=“date” />
  </form>
</remote_segment_type>
```

### Forms: Containers

In another preferred embodiment of remote segmentation system and method, containers allow staff to group logically similar form items together to create a user friendly interface for the marketer. For example, if the marketer is allowed to select multiple locales for a segment of transactions as well as a specific currency, but these two parameters must be specified together, the XML configuration could be modified to include a checkbox which toggles the visibility of these two fields. Using the “field” container followed by a collection of “display” containers, the checkbox toggles the entire “display” container referencing it by the name of the first form within that container. In this scenario, the checkbox is toggling the “locale” multibox which is in a “display” container with “currency.” In this example, an additional toggle checkbox was added to the dateframe tag. FIG. 5 is the resulting user interface 176 from the following XML configuration example.

```
<?xml version=”1.0” ?>
<remote_segment_type>
  <name>Name</name>
  <request_transport>http</request_transport>
  <request_method>get</request_method>
  <request_url>http://www.clientsite.com/segments/</request_url>
  <request_username>test</request_username>
  <request_password>test</request_password>
  <data_transport>ftp</data_transport>
  <data_host>ftp.bluehornet.com</data_host>
  <data_username>test</data_username>
  <data_password>test</data_password>
  <data_file>test_file.txt</data_file>
  <form>
    <checkbox container=″field″ name=″d_filter″ toggle=″date″>
      Fitler by time frame
    </checkbox>
    <dateframe container=″display″ name=″date″ />
    <checkbox container=″field″ name=″lc_filter″ toggle=″locale″>
      Filter by Locale and Currency
    </checkbox>
    <multibox container=″display″ name=″locale″ label=″Locale″>
      <option>en_US</option>
      ...
      <option>en_CA</option>
    </multibox>
    <dropdown container=″display″ name=″currency″ label=″Currency″>
      <option>USD</option>
      ...
      <option>CAD</option>
    </dropdown>
  </form>
</remote_segment_type>
```

### Forms: Tags in Depth

There are eight form specific tag types that can be defined in the “form” section of the XML configuration. Below are attributes, example code and screen renderings for each of the eight available form tags.

### Tag: <Decision>

Attributes:
required=[yes|no]
container=[field|display]
d1_name=CDATA
d2_name=CDATA
d3_name=CDATA
d4_name=CDATA
d5_name=CDATA

An example of the tag:<decision> is shown below, resulting in a user interface 178, as shown in FIG. 6.

```
<decision container=“field” required=“yes” d1_name=“have”
d2_name=“type”>
  Customers who !@(have not|have)@! purchased
  !@(specific products|product categories)@!
</decision>
```

### Tag: <textarea>

Attributes:
required=[yes|no]
container=[display]
name=CDATA

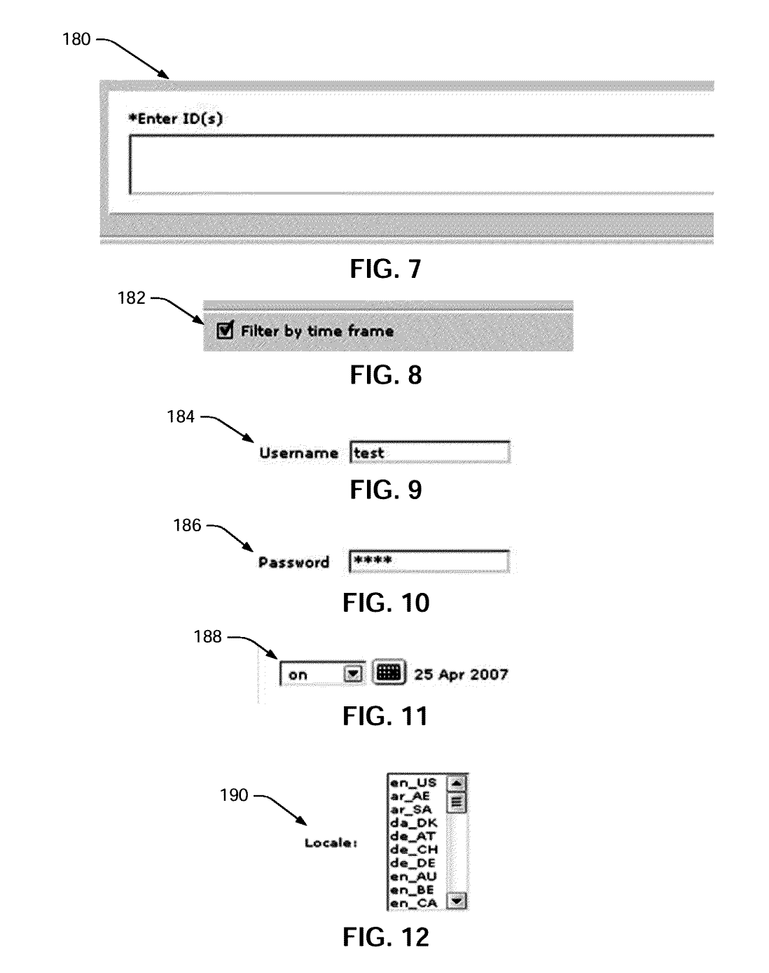

An example of the tag:<textarea> is shown below, resulting in a user interface 180, as shown in FIG. 7.

<textarea container=“display” required=“yes” name=“id_list”>
Enter ID(s)
</textarea>

### Tag: <Checkbox>

Attributes:
required=[yes|no]
container=[field|display]
name=CDATA
toggle=CDATA (Reference to another tag name)

An example of the tag:<checkbox> is shown below, resulting in a user interface 182, as shown in FIG. 8.

<checkbox container=”field” name=”time” toggle=”date”>
Filter by time frame
</checkbox>

### Tag: <Textbox>

Attributes:
required=[yes|no]
container=[display]
name=CDATA

An example of the tag:<textbox> is shown below, resulting in a user interface 184, as shown in FIG. 9.

<textbox container=“display” name=“data_username”>
Username
</textbox>

### Tag: <Passwordbox>

Attributes:
required=[yes|no]
container=[display]
name=CDATA

An example of the tag:<passwordbox> is shown below, resulting in a user interface 186, as shown in FIG. 10.

<passwordbox container=“display” name=“data_password”>
Password
</passwordbox>

### Tag: <Dateframe>

Attributes:
required=[yes|no]
container=[display]
name=CDATA

An example of the tag:<dateframe> is shown below, resulting in a user interface 188, as shown in FIG. 11.

<dateframe container=“display” name=“date”></dateframe>

### Tag: <Multibox>

Attributes:
required=[yes|no]
container=[display]
name=CDATA
label=CDATA

Children:
*<option>

An example of a tag:<multibox> is shown below, resulting in a user interface 190, as shown in FIG. 12.

```
<multibox container=“display” name=“locale” label=“Locale”>
  <option>en_US</option>
  <option>en_CA</option>
</multibox>
```

### Tag: <Dropdown>

Attributes:
required=[yes|no]
container=[display]
name=CDATA
label=CDATA

Children:
*<option>

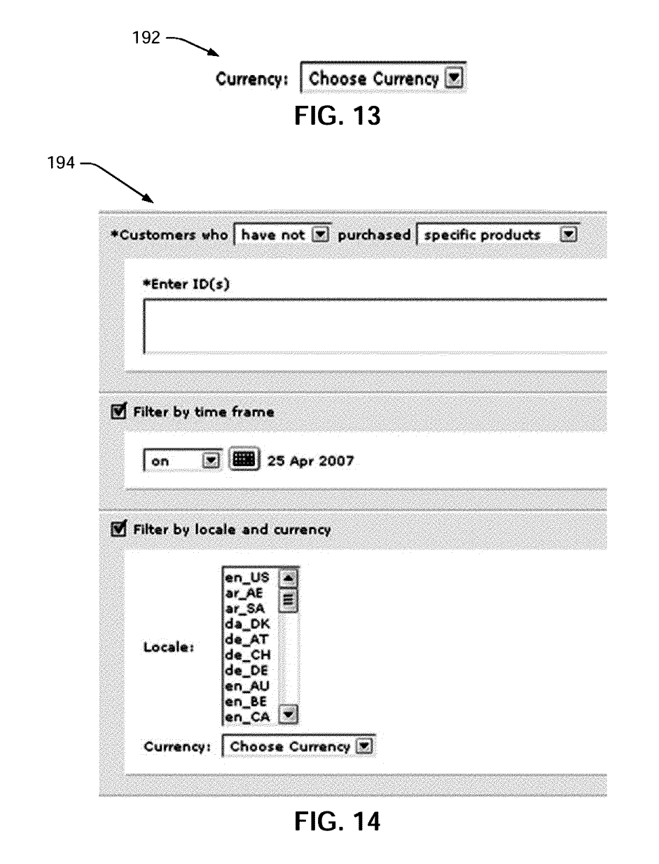

An example of a tag:<dropdown> is shown below, resulting in a user interface 192, as shown in FIG. 13.

```
<dropdown container=“display” name=“currency” label=“Currency”>
  <option>USD</option>
  <option>CAD</option>
</dropdown>
```

### Tag: <Option>

Attributes:
value=CDATA

Parents:
*<multibox>, <dropdown>

An example of this tag:<option> is shown below.

<option>USD</option>

### Forms: Putting it all Together

Shown below is an example XML configuration specific to an internal commerce data structure. In a preferred embodiment of remote segmentation system and method, the final XML configuration is similar. This results in a complex interface 194, as illustrated in FIG. 14.

```
<?xml version=“1.0”?>
<remote_segment_type>
  <name>globalCommerce</name>
  <request_transport>http</request_transport>
  <request_url></request_url>
  <data_transport>http</data_transport>
  <data_host></data_host>
  <data_username></data_username>
  <data_password></data_password>
  <data_file></data_file>
  <form>
    <decision container=“field” required=“yes”
    d1_name=“have” d2_name=“type”>
      Customers who !@(have not|have)@! purchased
      !@(specific products|product categories)@!
    </decision>
    <textarea container=“display” required=“yes” name=“id_list”>
      Enter ID(s)
    </textarea>
    <checkbox container=“field” name=“time” toggle=“date”>
      Filter by time frame
    </checkbox>
    <dateframe container=“display” name=“date”>Test</dateframe>
    <checkbox container=“field” name=“locale” toggle=“locale”>
      Filter by locale and currency
    </checkbox>
    <multibox container=“display” name=“locale” label=“Locale”>
      <option>en_US</option>
      ...
      <option>en_CA</option>
    </multibox>
    <dropdown container=“display” name=“currency” label=“Currency”>
      <option value=“”>Choose Currency</option>
      <option>USD</option>
      ...
      <option>CAD</option>
    </dropdown>
  </form>
</remote_segment_type>
```

### Component 2: Saved Remote Segment

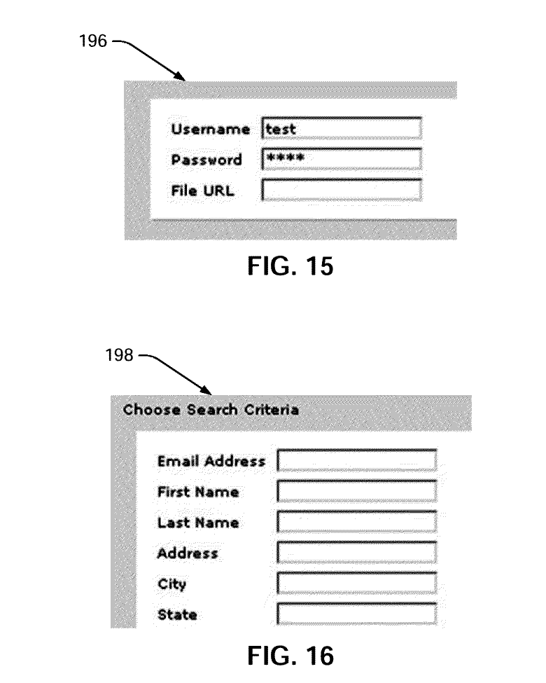

Saved remote segments are simply a set of parameters defined by the marketer within the context of the “form” tag from the remote segment type. For example, the following XML configuration results in an interface 196 as shown in FIG. 15.

```
<remote_segment_type>
  <name>HTTP</name>
  <data_transport>http</data_transport>
  <request_transport>none</request_transport>
  <form>
    <textbox container=“display” name=“data_username”>
      Username
    </textbox>
    <passwordbox container=“display” name=“data_password”>
      Password
    </passwordbox>
    <textbox container=“display” name=“data_file”>
      File URL
    </textbox>
  </form>
</remote_segment_type>
```

If the marketer has defined a username, password and URL, the saved remote segment will store the values for each field presented to the marketer. Because the request-transport is “none,” the remote segment functionality skips directly to the data file. Using HTTP, the remote segment functionality connects to data_file using data_username and data_password as authentication credentials.

A more complex example including an initial request for data follows:

```
<remote_segment_type>
  <name>BH Search</name>
  <request_transport>http</request_transport>
  <request_method>get</request_method>
  <request_url>http://www.bluehornet.com/bh_search.php</request_url>
  <request_username>test</request_username>
  <request_password>test</request_password>
  <form>
  <decision container=“field”>Choose Search Criteria</decision>
  <textbox container=“display” name=“email”>
    Email Address
  </textbox>
  <textbox container=“display” name=“firstname”>
    First Name
  </textbox>
  <textbox container=“display” name=“lastname”>
    Last Name
  </textbox>
  <textbox container=“display” name=“address”>Address</textbox>
  <textbox container=“display” name=“city”>City</textbox>
  <textbox container=“display” name=“state”>State</textbox>
  </form>
</remote_segment_type>
```

Resulting in a user interface 198, as shown in FIG. 16.

Assuming the marketer entered “CA” for state, the request URL will URL encode all parameters and append them as a query string to the request_url:

http://www.bluehornet.com/bh search.php?email=&firstname=&lastname=
&address=&city=&state=CA

### Component 3: Client-Side Remote Segment Interface

The client-side remote segment interface can be implemented in a number of ways. At the basic level, a client's IT staff can expose a set of data files made available on an ongoing basis. These data files can be referenced using the default “HTTP” or “FTP” remote segment types and can be made available to the marketer via a URL or host and file name.

For more complex implementations, a series of dynamic queries can be created to abstract the underlying data structures and expose a set of pre-defined parameters to the marketer. When using this type of implementation, understanding the way each form object affects the request is extremely important.

Tags, such as “textbox” and “passwordbox” pass the value directly as if the data was entered on a form; however, form objects such as the “dateframe” and “decision” create slightly different request parameters on the request_url. The following list of tags work outside of the “name=value” model commonly referred to as key/value pairs or query string parameters.

### Tag: <Decision>

The decision tag utilizes up to five attributes d1_name, d2_name, d3_name, d4_name and d5_name, to name each of the dropdowns available within the decision tag.

<decision d1_name=”fruit” d2_name=”color”>
!@(Apples|Bananas)@! are !@(red|yellow)@!
</decision>

When “Apples” and “red” are selected, the following parameters will be added to the request:
fruit=Apples&color=red

### Tag: <Dateframe>

The dateframe's name is used as a base for a set of parameters required to transmit the date matching type and the date itself. Additionally, when “within” is selected, an additional date is passed to complete the date range.
<dateframe name=“date”></dateframe>

If “on” and the date “1 Apr. 2025” are selected, the following parameters will be added to the request:
date_operator=on&date_single=2025-04-01

If “within,” “1 Apr. 2025,” and “29 Feb. 2026” are selected, the following parameters will be added to the request:

date_operator=within&date_multiple1=2025-04-01&date_multiple2=
2026-02-29

### Tag: <Multibox>

The multibox allows the marketer to select more than one distinct option for a list of many. To support this, the name for the multibox is appended with [ ] to allow for some languages to accept this subset of the request as an array.

```
<multibox name=”currency” label=”Currency”>
  <option>CAD</option>
  <option>USD</option>
</multibox>
```

If only “CAD” is selected, the following parameter will be added to the request:
currency[ ]=CAD

If both “CAD” and “USD” are selected, the following parameters will be added to the request:
currency[ ]=CAD&currency[ ]=USD

Table 3 describes an example XML language for remote segmentation. Table 4 describes XML configuration tags for quick reference purposes.

TABLE 3
Remote Segmentation XML Example

```
- <remote_segment_type>
  <name>globalCommerce</name>
  <data_transport>ftp</data_transport>
  <data_username />
  <data_password />
  <data_host />
  <data_file />
  <request_transport>http</request_transport>
  <request_url />
- <form>
  <decision container=“field” required=“yes” d1_name=“have”
    d2_name=“type”>Customers who !@(have not|have|will never)@!
    purchased !@(specific products|product categories)@!</decision>
  <textarea container=“display” required=“yes” name=“id_list”>Enter
    ID(s)</textarea>
  <checkbox container=“field” name=“time” toggle=“date”>Filter by time
    frame</checkbox>
  <dateframe container=“display” name=“date”>Test</dateframe>
  <checkbox container=“field” name=“locale” toggle=“locale”>Filter by
    locale and currency</checkbox>
- <multibox container=“display” name=“locale” label=“Locale”>
  <option>en_US</option>
  <option>ar_AE</option>
  <option>ar_SA</option>
  <option>da_DK</option>
  <option>de_AT</option>
  <option>de_CH</option>
  <option>de_DE</option>
  <option>en_AU</option>
  <option>en_BE</option>
  <option>en_CA</option>
  <option>en_CH</option>
  <option>en_FI</option>
  <option>en_GB</option>
  <option>en_HK</option>
  <option>en_IE</option>
  <option>en_IN</option>
  <option>en_MY</option>
  <option>en_NO</option>
  <option>en_NZ</option>
  <option>en_PR</option>
  <option>en_SG</option>
  <option>en_ZA</option>
  <option>es_AR</option>
  <option>es_CL</option>
  <option>es_CO</option>
  <option>es_ES</option>
  <option>es_MX</option>
  <option>es_PR</option>
  <option>fi_FI</option>
  <option>fr_BE</option>
  <option>fr_CH</option>
  <option>fr_FR</option>
  <option>it_IT</option>
  <option>iw_IL</option>
  <option>ja_JP</option>
  <option>ko_KR</option>
  <option>nl_NL</option>
  <option>no_NO</option>
  <option>pt_BR</option>
  <option>pt_PT</option>
  <option>sv_SE</option>
  <option>zh_CN</option>
  <option>zh_HK</option>
  <option>zh_TW</option>
    </multibox>
- <dropdown container=“display” name=“currency” label=“Currency”>
  <option value=“”>Choose Currency</option>
  <option>USD</option>
  <option>USD-DUP</option>
  <option>AED</option>
  <option>ARS</option>
  <option>AUD</option>
  <option>BRL</option>
  <option>CAD</option>
  <option>CHF</option>
  <option>CLP</option>
  <option>CNY</option>
  <option>COP</option>
  <option>DKK</option>
  <option>EUR</option>
  <option>GBP</option>
  <option>HKD</option>
  <option>INR</option>
  <option>JPY</option>
  <option>KRW</option>
  <option>MXN</option>
  <option>MYR</option>
  <option>NOK</option>
  <option>NZD</option>
  <option>PLN</option>
  <option>SAR</option>
  <option>SEK</option>
  <option>SGD</option>
  <option>SIT</option>
  <option>TWD</option>
  <option>ZAR</option>
    </dropdown>
    </form>
    </remote_segment_type>
```

TABLE 4
XML Configuration Tag Quick Reference

| Tag Name | Attributes | Short Description |
|---|---|---|
| Name | none | The name of the remote segment type |
| request_transport | none | “none” or “http” |
| request_method | none | “get” or “post” |
| request_url | none | The URL |
| request_username | none | The authentication username for the |
| | | request (HTTP only) |
| request_password | none | The authentication password for the |
| | | request (HTTP only) |
| data_transport | none | “ftp,” “http,” or “local” (“local” is |
| | | rarely used) |
| data_host | none | Hostname for the data location (FTP |
| | | only) |
| data_username | none | The authentication username for the |
| | | data location (FTP or HTTP) |
| data_password | none | The authentication password for the |
| | | data location (FTP or HTTP) |
| data_file | none | The name of the file containing email |
| | | addresses or email service provider |
| | | internal contact id's |
| ssl_ftp | none | Set to “1” to use FTP over SSL. |
| Form | none | Contains marketer-visible form data. |
| decision | d1_name, | A sentence that has a series of |
| | d2_name, | dropdowns and allows a marketer to |
| | d3_name, | make a logical decision. |
| | d4_name, | |
| | d5_name, | |
| | container, | |
| | required | |
| textarea | name, | A large area for text entry. |
| | container, | |
| | required | |
| checkbox | | A checkbox for toggling on and off. |
| textbox | name, | A standard text box for short text. |
| | container, | |
| | required | |
| passwordbox | name, | A password box for hidden text. |
| | container, | |
| | required | |
| dateframe | name, | A date object supporting “on,” |
| | container, | “before,” “after,” and “within” |
| | required | |
| multibox | name, | A box allowing selection of multiple |
| | container, | items from a list. Accepts “option” |
| | required, | tags. |
| | label | |
| dropdown | name, | A dropdown allowing selection of a |
| | container, | single item from a list. Accepts |
| | required, | “option” tags. |
| | label | |

### Segmentation Engine

A preferred embodiment of a remote segmentation system and method provides an advanced segmentation engine that allows clients to segment subscribers based on commerce and behavioral data. The result of this process is a segment—a saved query to a remote segmentation system accessing a segmentation data mart. Such a system provides the user with a list of subscribers most likely to find the marketing message meaningful and relevant.

TABLE 5
Use Case 2
Use Case 2

A system administrator accesses various sources of data which the
user has available. Data is extracted from those systems and
imported into a segmentation data mart.
A system administrator configures the system to point to a
segmentation data mart location containing data from a plurality of
sources. The user then creates segments in the system on a new
segments page. This page allows the user to create segments in one
of two ways: by selecting criteria for the type of group for which the
message will be created by stored segments, or by inserting ad hoc
criteria to create a custom segment. The user accesses the system
to obtain a count of the subscribers fitting the query criteria. The user
may repeat this process as necessary to refine the resulting list, and
save it when it is satisfactory.
The user then creates messages that will use the segment and
schedules them for sending.
At the time of message send, the system detects that the message to
be sent contains a segment. The system retrieves the segment,
initiates the process to retrieve the email addresses that meet the
criteria at the time and sends the message to the subscribers on the
list.

Referring back to FIG. 1, this embodiment is similar to that described above (and illustrated here) with the exception that the system 102 accessing Box 114 is now accessing a segmentation data mart containing data from a plurality of sources.

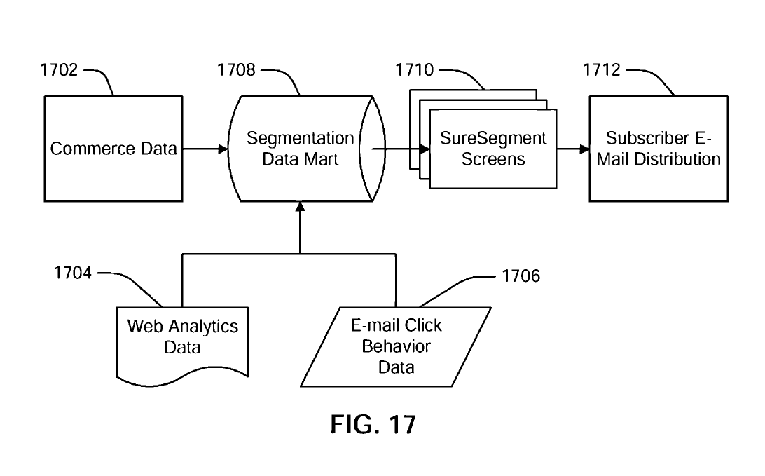

Referring now to FIG. 17, a segmentation data mart 1708 may consist of data imported from any number of sources, such as the marketer's commerce data 1702 (web site or physical store), a web analytics system 1704 and an e-commerce system 1706. Data transfer from an external system to the segmentation data mart may be performed by any type of data import process, such as FTP (File Transfer Protocol) or XML, using a pre-defined file structure.

A preferred embodiment may contain data covering any time frame required by the marketer's needs and the system capacity. Customized segmentation screens 1710 may be created using a remote segmentation process on a segmentation data mart 1708. With access to the data mart, the marketer may first obtain a count of email subscribers fitting the query criteria. This data will allow the marketer to determine whether the segments are large enough to capture a positive return on investment (ROI). If the count is acceptable, the marketer may use the query to obtain a distribution list of the subscribers for whom his/her marketing campaign is most relevant and distribute targeted email advertising to the subscribers on the list. The segmentation query used to produce the list is saved for future use, and will extract an updated list as the data mart is updated.

Marketers may be offered a number of versions of the segmentation system, each reflecting a different degree of complexity and number of data sources. For instance, one offering may provide segmentation based only on purchases made online; while another may segment based on commerce data, additional demographics provided by a data enhancement service, and potential response to email advertising.

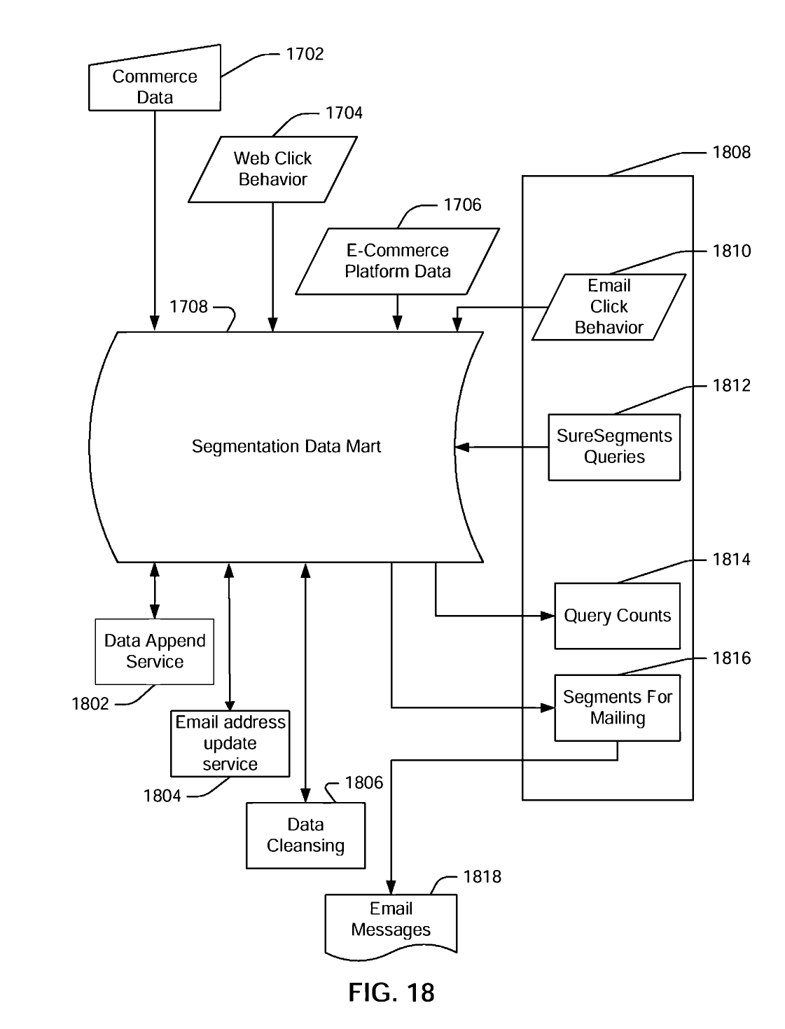

FIG. 18 illustrates the functional flow of a preferred embodiment of the system and its inputs, interfaces, services and outputs in more detail. The data mart 1708 may import data from the client commerce system 1702 (purchasing behavior at a “brick-n-mortar” or an online store), a web analytics system 1704 (web click behavior) and an e-commerce system 1706 (purchasing behavior on a third party site). The data may then be processed through various services, such as a data append or enhancement service 1802 (e.g. to add demographic or lifestyle information), an email address update service 1804 (e.g. provide updated email address information to minimize misdirected or bounced emails), a data cleansing service 1806 (e.g. to normalize data, provide data verification, duplicate removal, and screen for opt-out addresses), and an email marketing system 1810 (e.g. to add email click behavior). These inputs provide data that will give the most comprehensive picture of the subscriber, allowing the marketer to extract a distribution list of the target audience most relevant to the marketing campaign. One skilled in the art could recognize that there are a number of systems that may provide data that would enhance the segmentation process. For instance, a credit rating service may expose its data to third parties, allowing the data mart to provide a data file containing the names and email addresses of its members and receive the associated credit data in return.

A marketer accessing the data mart from the email marketing system 1808, may create queries for commerce, based on parameters relevant to the marketing campaign. The queries return a count 1814 of relevant subscribers. The marketer may use this data to determine if the campaign will meet its ROI goals. The marketer saves the query segments 1816. The list provided by the query is then used as the distribution list for providing email marketing materials to the most relevant audience 1818. The query, or segment, is saved in the email marketing system and may be reused at a later date with updated data for subsequent email campaigns.

Different levels of complexity may be offered to marketers. The marketer could choose to query both commerce and behavioral data or only commerce or only behavioral data. The marketer could further choose to query only one commerce data feed or a plurality of commerce data feeds; or one behavioral data feed or a plurality of behavioral data feeds. A preferred embodiment of the system provides a number of stored segment queries that the marketer may choose from and allows for ad hoc queries.

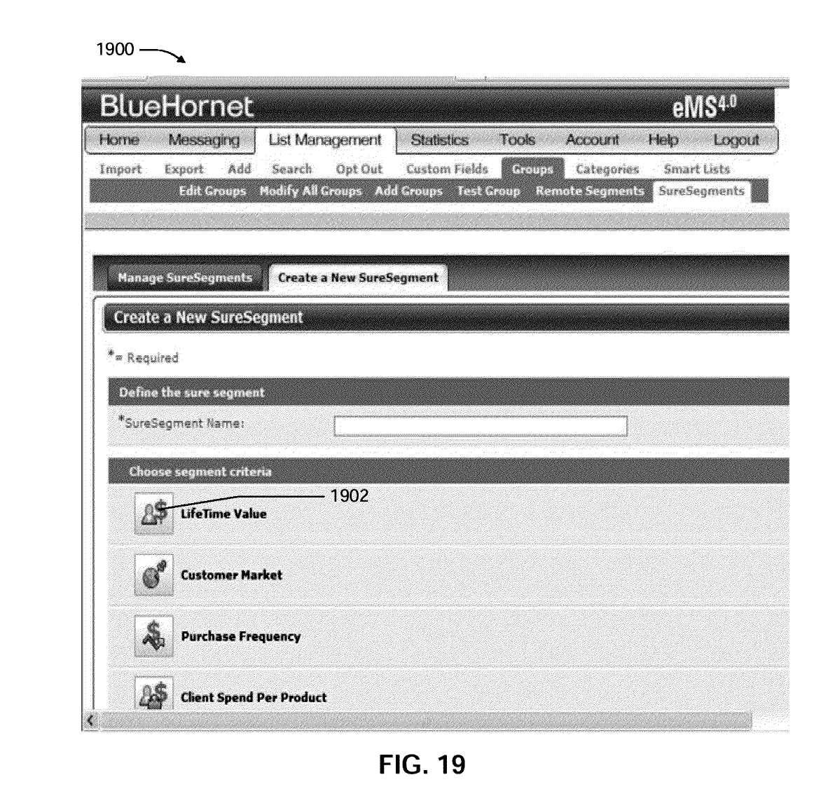

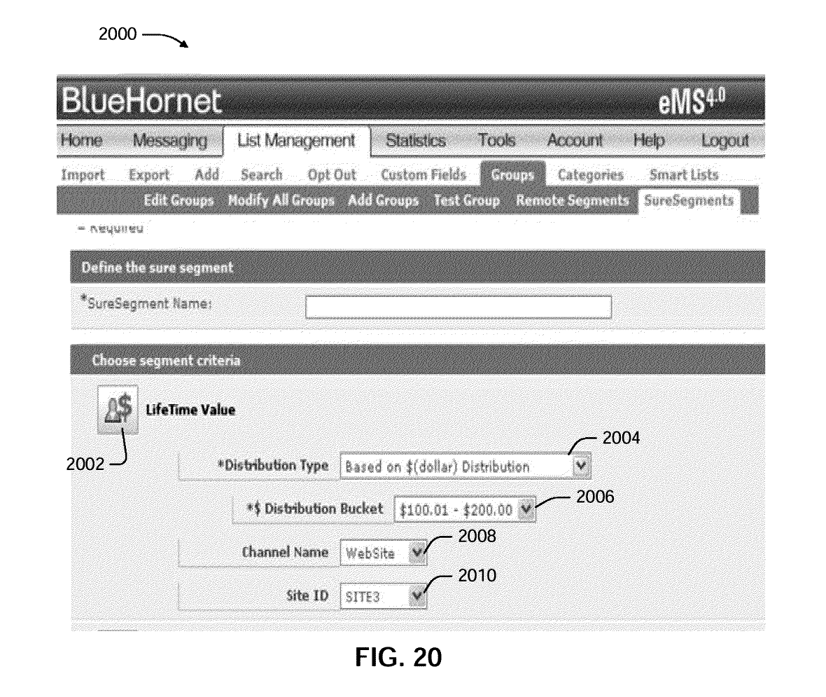

FIG. 19 is a screen shot 1900 of an example segment stored segment list, which allows the marketer to choose criteria for the segment. When the marketer clicks on the icon 1902, the section expands to provide a list of parameters available to the particular query, as shown in FIG. 20. FIG. 20 illustrates 2000 the selection of criteria for a chosen segment. Values in the drop downs may be populated by buckets defined in a data warehouse account associated with the marketer's email marketing system account. In this example, the marketer wants to extract a list of subscribers with a lifetime value; s/he clicks on the associated icon 2002 to access the dropdown menus 2004, 2006, 2008, 2010, to define selection criteria. The marketer may wish to determine those subscribers with a LifeTime Value based on dollar distribution, distribution type 2004, with a distribution bucket of $100.01-$200.00 2006 originating from a web site channel. The Site ID 2010 indicates the marketer's web site identifier. The output for this segment is the number of subscribers meeting the selected criteria. The marketer may then decide if the return on investment of a marketing campaign to the identified subscribers meets its marketing goal; if not, additional segment parameters may be entered and evaluated. The segment may be saved and used to populate a “recipient” field defining the distribution list for a particular message in the email marketing system.

A sampling of the stored relevant and actionable extracts for marketers are listed in Table 6. As described above, each query returns a count, and upon acceptance by the requesting marketer, an extract of email addresses for subscribers meeting the specified criteria.

TABLE 6
Sample Segments

| Segment | Description |
|---|---|
| Lifetime value | Group/segment customers by their overall |
| | lifetime value |
| Client spend per product | Group customers by dollars spent per product |
| | over a specified time period |
| Purchase frequency | Group customers based on frequency of |
| | purchases |
| Purchase recency | Provide segmented list of customers based on |
| | recency of last purchase |
| Marketer-defined event | Contact customers based on the category of |
| messaging | products purchased or viewed, content |
| | category, or target specific geographic region |
| Client spend per product | Group customers from the same geographic |
| by market | location by dollars spent per product over a |
| | specified time period |
| Cross-sell | Provide cross-sell recommendations for |
| recommendation by | customers who made a purchase during a |
| product | specified time period based on their purchase |
| | history and opt-in status to receive product |
| | communications. |
| Customer market | Provide a list of customers within specified |
| segmentation | number of miles of a targeted zip code or in a |
| | defined target market segment |
| Availability Notification | Notify customers when a product they've |
| | expressed interest in during a specified time |
| | period becomes available |
| Browsers and operating | Provide a list of customers who use a specific |
| systems | operating system and/or browser type |
| Cart Abandonment/Form | Provide follow up for cart or form |
| Abandonment | abandonment |
| Revenue generation per | Evaluate how much revenue has been spent |
| marketing program | per program per customer |
| Acquisition program | Evaluate how much revenue customers bring |
| value analysis | through their lifetime broken down by program |
| | through which they were initially acquired. |
| Revenue per channel | Evaluate revenue acquired per sales channel |

To create a segment, the customer first arranges for commerce data to be imported in the segments data mart. Once it is successfully loaded, the user can create a new segment using the query selection drop downs available on a segments selection page. The user selects a segment that includes purchasers of a specific product from a dropdown list. The unique values of the products available in the data mart appear in the drop down menu. The user selects a timeframe that the product was purchased. The system provides a count of the subscribers that meet the selected criteria. If the count is acceptable, the subscriber saves the segment to be used later when sending a message.

Marketers create a message for their marketing campaign. They may select a one time, time-released or recurring message to which the segment may apply. A segment being used in a recurring message may be deleted by cancelling the segment.

The marketer may log in and navigate to the segments page and selects a segment that includes purchasers of a specific product from a dropdown list. The unique values of the products available in the data mark appear in the dropdown menu. The marketer selects a time frame that the product was purchased. The system provides an immediate (within 30 seconds) response of the number of subscribers that meet the criteria on the screen. If the count is acceptable, the marketer may save the segment to apply to a message. The marketer may then navigate to a messaging page (message wizard) and choose the type of message to send (i.e. advanced message, recurring message), selecting the segment that he/she just created on the segment page.

To create a message, the user creates a rich text message (a new or reoccurring message). Each occurrence of a reoccurring message returns the subscribers in the segment according to the segment data refresh rules (updated daily, weekly, etc). The user saves the message as a draft. Changes to the segment may be made on the version before the draft version is sent. Any changes to the segments may affect the subscribers that receive the message. An alert tells the user that the draft message included a segment that has been changed. The user shows links and saves as draft.

Various combinations of data may be made available to a marketer. All segment offerings may support a concept of multiple stores per channel (e.g., web, brick-n-mortar store, catalog, website, etc.) and allow some breakdown by store (site) ID. It is possible to have multiple channels as well as multiple stores (sites) within the same channel; one feed per channel; multiple feeds per channel with different store (site) IDs. For instance, one could have a “catalog” channel with one feed and no site/store IDs. In addition, there could be a “brick-n-mortar” channel, with one feed for all of them, but site/store ID added to each transaction. Finally, there could be an e-commerce channel, with multiple feeds, one per siteID. In order to properly break down transactions in this example, a siteID attribute should be added to each transaction or, if channels don't break down by siteID, a channel name should be specified instead.

### Populating the Segmentation Database

A segmentation database may be populated with commerce and behavioral data from a plurality of sources, including web pages populated with site tags providing data to a web analytics system, data feeds from a plurality of commerce systems or channels, including catalog, resellers, merchant hosted websites, etc. The marketing customer (marketer) may arrange for and provide login credentials and FTP location for any data it desires to import.

Web site tags can conceivably provide enough data to allow a marketer to segment customers based on web behavior, however, there are some drawbacks to segmenting by tags alone. For instance, if a consumer deletes cookies valuable data can be missing. Also, tags cannot pick up subsequent transactions, such as a return on an order. Web analytics data may be provided from multiple sources. Real-time or near real-time data may be available in the system via system tags used to collect data via cookies. All the tags described here and multi-channel feed fields provided by a feed API may be used to produce results in a segmentation system. Providing a subset of tags and feed fields will limit the reports that are available to the user. A list of suggested tags to get a full set of reports is provided below in Table 7.

TABLE 7
Web Site Tags

| Tag | Description |
|---|---|
| fc_user | Dimensional tag containing the following |
| | dimensions: userID/email address/name/opt- |
| | in status/customer market/street |
| | number/street |
| | name/city/state/zip/country/phone number |
| | (where “/” is the dimension separator |
| | configurable in the analytic system and should |
| | be the same for all dimensional tags). If any |
| | dimensions are not being used, use “-” for |
| | each unused dimension. It is recommended |
| | to set this tag when the user logs in and when |
| | user profile is changed. |
| fc_prod_add, | At least three dimensions are required; |
| fc_prod_remove, | product name, product category, and product |
| fc_prod_buy, | expiration in days. |
| fc_prod_view | |
| fc_prod_interest | Must include at least a product name |
| | (optionally, all product dimensions could be |
| | provided) |
| fc_program | Program ID (optionally a descriptive name as |
| | a second dimension) |
| fc_offer | Offer ID (optionally a descriptive name as a |
| | second dimension) |
| fc_form_track | |
| fc_order | Order total; must be equal to the total of all |
| | products in fc_prod_buy with quantity taken |
| | into account with tax & shipping added |
| fc_click function | |
| fc_site | Used to facilitate store or siteID breakdown. |

External system feeds may be provided for the desired granularity, such as daily, weekly or monthly. The associated segment criteria would need to identify what kind of granularity was available. In the case of daily granularity, files may contain all activity for the previous day with a file name indicating the date of the activity. Each transaction in the feed may contain transaction details for one of selected transaction types (e.g. new order, return, fraud queue addition, fraud queue removal, product view, product addition to cart, product removal from cart, product interest, content view, form abandonment, ad click, download, and userinfo change) as well as user information associated with each transaction. A example of a Document Type Definition (DTD) file for an XML API is provided in Table 8.

TABLE 8
Sample DTD File

```
<!-- The top-level element is “transactions”, which
contains a channel, date of the file, and zero or more
transactions -->
<!ELEMENT transactions
(channel,date,(order|return|fraud_add|fraud_remove|product_view|
product_add|product_remove|product_interest|content_view|
form_abandon|ad_click|download|user_change)*)>
<!ELEMENT channel (#PCDATA)>
<!ELEMENT date (#PCDATA)>
<!-- COMMONLY USED ELEMENTS -->
<!ELEMENT site_id (#PCDATA)>
<!ELEMENT order_id (#PCDATA)>
<!ELEMENT session_id (#PCDATA)>
<!ELEMENT transaction_id (#PCDATA)>
<!ELEMENT datetime (#PCDATA)>
<!-- COMMONLY USED ELEMENTS: attributes are general purpose
name/value pairs -->
<!ELEMENT attributes (attribute)*>
<!ELEMENT attribute (attribute_name,attribute_value)>
<!ELEMENT attribute_name (#PCDATA)>
<!ELEMENT attribute_value (#PCDATA)>
<!-- COMMONLY USED ELEMENTS: user_info describes the end-
user -->
<!ELEMENT user_info
(user_id?,name?,address1?,address2?,address3?,city?,state?,
zip?,country?,phone?,email,market?,opt_in?,attributes?)>
<!ELEMENT user_Id (#PCDATA)>
<!ELEMENT name (#PCDATA)>
<!ELEMENT address1 (#PCDATA)>
<!ELEMENT address2 (#PCDATA)>
<!ELEMENT address3 (#PCDATA)>
<!ELEMENT city (#PCDATA)>
<!ELEMENT state (#PCDATA)>
<!ELEMENT zip (#PCDATA)>
<!ELEMENT country (#PCDATA)>
<!ELEMENT phone (#PCDATA)>
<!ELEMENT email (#PCDATA)>
<!ELEMENT market (#PCDATA)>
<!ELEMENT opt_in (#PCDATA)>
<!-- COMMONLY USED ELEMENTS: product_info describes a
product that has been added or purchased.
  product_view_info describes a product at the level of
interest but not purchase (so no
  quantity, for example). -->
<!ELEMENT product_info
(product_category,product_name,product_id?,product_days_to_{—}
expire?,product_quantity?,product_price?,attributes?)>
<!ELEMENT product_view_info
(product_category,product_name,product_id?,product_price,
attributes?)>
<!ELEMENT product_category (#PCDATA)>
<!ELEMENT product_name (#PCDATA)>
<!ELEMENT product_id (#PCDATA)>
<!ELEMENT product_days_to_expire (#PCDATA)>
<!ELEMENT product_quantity (#PCDATA)>
<!ELEMENT product_price (#PCDATA)>
<!-- TRANSACTIONS -->
<!ELEMENT order
(datetime,site_id?,order_id,session_id?,product_info*,total?,
program_id?,offer_id?,user_info,attributes?)>
<!ELEMENT total (#PCDATA)>
<!ELEMENT program_id (#PCDATA)>
<!ELEMENT offer_id (#PCDATA)>
<!ELEMENT return
(datetime,site_id?,order_id, (product_info)*,total?,user_info,
attributes?)>
<!ELEMENT fraud_add
(datetime,order_id,user_info,attributes?)>
<!ELEMENT fraud_remove
(datetime,order_id,user_info,attributes?)>
<!ELEMENT product_view
(datetime,site_id?,session_id?,transaction_id?, (product_view_info)+,
user_info,attributes?)>
<!ELEMENT product_add
(datetime,site_id?,session_id?,transaction_id?, (product_info)+,
user_info,attributes?)>
<!ELEMENT product_remove
(datetime,site_id?,session_id?,transaction_id?, (product_info)+,
user_info,attributes?)>
<!ELEMENT product_interest
(datetime,site_id?,session_id?,transaction_id?, (product_view_info)+,
user_info,attributes?)>
<!ELEMENT content_view
(datetime,site_id?,session_id?,transaction_id?,content_info,
user_info,attributes?)>
<!ELEMENT content_info (content_category,content_name?)>
<!ELEMENT content_category (#PCDATA)>
<!ELEMENT content_name (#PCDATA)>
<!ELEMENT form_abandon
(datetime,site_id?,session_id?,transaction_id?,form_name,user_info,
attributes?)>
<!ELEMENT form_name (#PCDATA)>
<!ELEMENT ad_click
(datetime,site_id?,session_id?,transaction_id?,ad_name,user_info,
attributes?)>
<!ELEMENT ad_name (#PCDATA)>
<!ELEMENT download
(datetime, site_id?,session_id?,transaction_id?,download_name,
user_info,attributes?)>
<!ELEMENT download_name (#PCDATA)>
<!ELEMENT user_change
(datetime,site_id?,session_id?,user_info,attributes?)>
```

### Extracting Segments

In a preferred embodiment of a remote segmentation system and method, the marketer logs into the email marketing system. The marketer creates a segment that queries the data mart and returns a count of subscribers that meet the criteria. If the count is acceptable, the marketer saves the segment. When the marketer chooses to send a message, the segment is selected and saved. The email marketing system will use the segment in distributing the message. The segment may also be added to, or deleted from, a configuration file for sending recurring or timed-release messages.

The email marketing system makes several XML API calls to the segmentation data mart to populate the segment. These include retrieving a list of values with which to populate drop downs, pulling stored segments and pulling ad-hoc segments. An example of a stored segment (FIG. 20) 2000 is the LifeTime Value (LTV) of the subscriber 2002. Table 9 contains XML for retrieving a Lifetime Value (LTV) segment. Other segments will be very similar in format.

TABLE 9
Remote Segment XML for Retrieving LTV Segment

```

[symbol]
?xml version=“1.0” encoding=“UTF-8” ?> [symbol]
Result>
  - <Query>
      <Serial>golfstfxbv</Serial>
    - <Options>
      <Command>pluto.pluto.pluto.pluto*date-
        last=180,force=true,metrics=600,segments=651,slice=pluto-
        none,type=I,user=admin</Command>
      <Identifier />
      <ForceExecution />
      </Options>
      <TimeRange end=“2007-06-11 00:00:00” start=“2007-06-10
        00:00:00” />
    - <Region>
    - <Slice idWidth=“63” name=“Segments Lifetime Value
    Distribution”>
      <Attribute name=“LTVDistribution” />
        </Slice>
      </Region>
    - <Measures>
    - <Measure aggregate=“none” name=“Constant One”>
      <Integer value=“1” />
        </Measure>
      </Measures>
  </Query>
  - <Status>
      <Errors />
      <Warnings />
      <ExecutionTime>0</ExecutionTime>
      <PredictedExecutionTime>−1</PredictedExecutionTime>
  </Status>
  <TimeRange end=“2007-12-07 16:00:00” start=“2006-08-07
  00:00:00” />
  - <Data>
    - <Dimension>
      <Name>$0.00 - $50.00</Name>
    - <Values>
      <Value>0</Value>
        </Values>
        </Dimension>
    - <Dimension>
      <Name>$50.01 - $100.00</Name>
    - <Values>
      <Value>0</Value>
        </Values>
        </Dimension>
    - <Dimension>
      <Name>$100.01 - $200.00</Name>
    - <Values>
      <Value>0</Value>
        </Values>
        </Dimension>
    - <Dimension>
      <Name>$200.01 - $400.00</Name>
    - <Values>
      <Value>0</Value>
        </Values>
        </Dimension>
  </Data>
</Result> [symbol]
indicates data missing or illegible when filed
```

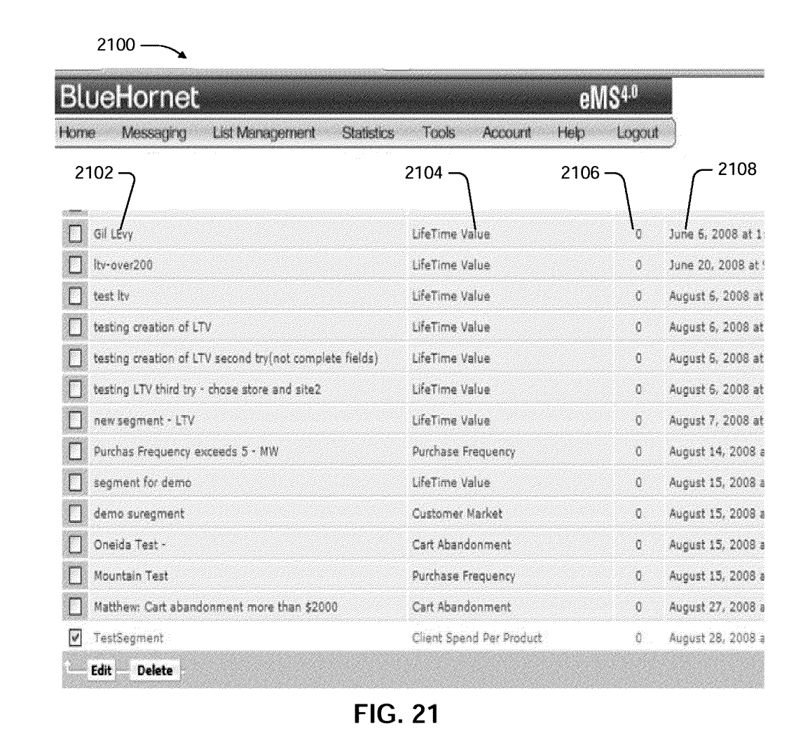

FIG. 21 is the results page of a remote segmentation system where the segment is identified by name 2102 and type 2104. A count 2106 is the single value returned prior to finalizing and saving the segment. The date 2108 the query was last run is displayed as well. A marketer may later return to this page, select the segment, modify the criteria, if desired, and rerun the query for a new, updated count and list.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the web interface such that different dialog boxes are presented to a user that are organized or designed differently while maintaining substantially the same functionality without departing from the scope and spirit of the present invention.

What we claim:

1. A computerized segmentation system for use on a network, comprising:
a data mart containing information;
a software module operatively configured to send a request to the data mart and receive a response from the data mart;
a remote segmentation engine operatively configured to segment information in the data mart based on the request; and
a dynamic user interface operatively configured to change access to the information determined from a user defined rule based on the data in the data mart.

2. The system of claim 1 wherein the information in the data mart comprises information imported from a plurality of sources identifying at least one of: demographics, preferences, behaviors, and transactions.

3. The system of claim 1 wherein the request sent to the data mart comprises a query to find records with specified criteria and the response from the data mart consists of a count of records returned by the query.

4. The system of claim 1 wherein the segmentation engine is operatively configured to filter segments based on a time frame.

5. The system of claim 1 wherein the system is operatively connected to an e-mail marketing system to which the segment information provided by the segmentation engine are imported.

6. The system of claim 1 wherein the remote segmentation engine is operatively configured to continually receive updated data requests through the user interface for data segments.

7. The system of claim 1 wherein a format of the request and response is selected from a group consisting of: extensible markup language format and text format.

8. The system of claim 1 wherein the remote segmentation engine is operatively configured to request remote segments based on a count of information.

9. A method for segmenting data for e-mail marketing remotely on a network, comprising steps of:
importing information into a data mart;
sending a request to the data mart containing information;
segmenting the information based upon the request;
receiving a response with segmented information; and
changing access to information in a dynamic user interface determined from a user defined rule.

10. The method of claim 9 wherein the data mart contains data from a plurality of sources where the sources may be at least one of: demographics, preferences, behaviors, and transactions.

11. The method of claim 9 further comprising a step of dynamically creating extensible markup language to accommodate ad hoc queries.

12. The method of claim 9 wherein the request sent to the data mart comprises a query to find records with specified criteria and the response consists of a count of records returned by the query.

13. The method of claim 9 wherein the sending step comprises sending an e-mail is sent, according to a preconfigured value for a saved query.

14. The method of claim 9 wherein the receiving step further includes obtaining updated data requests through the user interface for data segments.
